(19) United States
(12) Patent Application Publication
(10) Pub. No.: US 2012/0069057 A1
(43) Pub. Date: Mar. 22, 2012

(54) LIQUID CRYSTAL DISPLAY DEVICE AND DRIVING METHOD FOR LIQUID CRYSTAL PANEL

(75) Inventor: Hiroaki Ikeda, Tokyo (JP)

(73) Assignee: NEC Display Solutions, Ltd., Minato-ku, Tokyo (JP)

(21) Appl. No.: 13/138,780

(22) PCT Filed: Mar. 30, 2009
(86) PCT No.: PCT/JP2009/056475

§ 371 Date: Nov. 28, 2011

(51) Int. Cl. G09G 5/10; G09G 3/36; G09G 5/00

(52) U.S. Cl. 345/690; 345/212; 345/87

(57) ABSTRACT

A liquid crystal display device having a liquid crystal panel includes a common voltage generating section (5) that supplies a common voltage to a common electrode connected in common to a plurality of liquid crystal cells that comprise said liquid crystal panel (13); a liquid crystal driving section (12) that supplies a voltage corresponding to an input image signal to said plurality of liquid crystal cells so as to display an image based on said input image signal on said liquid crystal panel (13); and a controlling section (10) that causes said common voltage generating section (15) to change a value of the common voltage generated thereby to correspond to a signal that represents an amount of light that enters said liquid crystal panel.

### TECHNICAL FIELD

The present invention relates to a liquid crystal display device, in particular, to a technique that drives a liquid crystal panel.

### BACKGROUND ART

Liquid crystal panels are composed of a plurality of liquid crystal cells. Each liquid crystal cell is structured to sandwich a liquid crystal with two electrodes. One electrode is a pixel electrode corresponding to an image display pixel and is charged and discharged at a voltage corresponding to an image signal through a thin film transistor (TFT). The other electrode is a common electrode connected to each liquid crystal cell. A common voltage (DC voltage) is applied to the common electrode.

The characteristics of the liquid crystal panel are prevented from deteriorating by driving pixel electrodes with AC power and setting a common voltage value (fixed voltage value) applied to the common electrode such that a DC voltage is not applied to the liquid crystal. JP2008-164852A publication (hereinafter refer to as Patent Literature 1) presents a technique that divides a screen into a plurality of areas, computes characteristic amounts of an image signal every area, and sets an optimum common voltage based on the computed characteristic amounts.

### SUMMARY OF THE INVENTION

In the liquid crystal panel where the voltage of an image signal is supplied to pixel electrodes through respective thin film transistors, a leak current whose amount corresponds to the amount of incident light (light energy and heat energy) occurs. When the amount of light that enters the liquid crystal panel is varied for high contrast, the amount of leak currents also varies. For example, in the case in which if high brightness is accomplished by maximizing the amount of light, a bright image is displayed and in which if the contrast is improved by restricting the amount of light, a dirk image is displayed, the amount of leak current varies in line with variation in the amount of light. When the amount of leak current varies, since the set value of the common voltage deviates from the optimum value (at which a DC voltage is not applied to the liquid crystal), the characteristics of the liquid crystal panel deteriorates.

Moreover, when the set value of the common voltage deviates from the optimum value, problems of flicker, decrease of contrast, color shear, and so forth may occur as described in the following.

FIG. 8 exemplifies the waveform of an image signal according to the line reverse driving scheme that reverses the polarity of the image signal every horizontal scanning interval. The positive potential side of the waveform of this image signal to the common potential is a positive polarity image signal, whereas the negative potential side of the waveform of the image signal to the common potential is a negative polarity image signal.

A center voltage is a voltage supplied to the liquid crystal panel as an intermediate potential between the positive polarity signal and negative polarity signal of the input image signal. The positive polarity image signal and negative polarity image signal are vertically symmetrical with respect to the center potential. If the common voltage value deviates from the optimum value, a difference occurs between the relationship of the positive polarity image signal that displays a particular gradation and the common voltage and the relationship of the negative polarity image signal thereof and the common voltage and thereby the difference is recognized as flicker.

Moreover, when a black image is displayed, if the common voltage value deviates from the optimum value, since the potential of one electrode of the image signal is not a sufficient potential that allows a black image to be displayed, the black image does not clearly appear. Thus, the contrast deteriorates.

Furthermore, when the potential between the image signal and the common voltage fluctuates, the brightness of each color varies and thereby a color shear takes place.

In the technique presented in Patent Literature 1, if the amount of light that enters the liquid crystal panel is varied, the set value of the common voltage deviates from the optimum value and thereby the above described problems occur.

An object of the present invention is to provide a liquid crystal display device and a driving method for a liquid crystal panel that allows the common voltage value to be the optimum value even if the amount of light that enters the liquid crystal panel is varied.

To accomplish the above-described object, a liquid crystal display device including a liquid crystal panel according to one aspect of the present invention comprises:

a common voltage generating section that supplies a common voltage to a common electrode connected in common to a plurality of liquid crystal cells that compose said liquid crystal panel;

a liquid crystal driving section that supplies a voltage corresponding to an input image signal to said plurality of liquid crystal cells so as to display an image based on said input image signal on said liquid crystal panel; and

a controlling section that causes said common voltage generating section to change a value of the common voltage generated thereby to correspond to a signal that represents an amount of light that enters said liquid crystal panel.

A liquid crystal display device that has a liquid crystal panel according to another aspect of the present invention comprises:

a common voltage generating section that supplies a common voltage to a common electrode connected in common to a plurality of liquid crystal cells that comprise said liquid crystal panel;

a liquid crystal driving section that supplies a voltage corresponding to an input image signal whose polarity reverses every predetermined interval to said plurality of liquid crystal cells so as to display an image based on said input image signal on said liquid crystal panel; and

a controlling section that changes a value of a center voltage supplied to said liquid crystal panel as an intermediate potential between a positive polarity signal and a negative polarity signal of said input image signal corresponding to a signal that represents an amount of light that enters said liquid crystal panel.

A driving method for a liquid crystal panel including a plurality of liquid crystal cells according to one aspect of the present invention, comprises:

supplying a voltage corresponding to an input image signal to said plurality of liquid crystal cells so as to display an image based on said input image signal on said liquid crystal panel and then supplying a common voltage to a common electrode connected in common to said plurality of liquid crystal cells; and

changing a value of the common voltage supplied to said common electrode to correspond to a signal that represents an amount of light that enters said liquid crystal panel.

A driving method for a liquid crystal panel composed of a plurality of liquid crystal cells according to another aspect of the present invention, comprises:

supplying a voltage corresponding to an input image signal whose polarity reverses every predetermined interval to said plurality of liquid crystal cells so as to display an image based on said input image signal on said liquid crystal panel and then supplying a common voltage to a common electrode connected in common to said plurality of liquid crystal cells; and

changing a value of a center voltage supplied to said liquid crystal panel as an intermediate potential between a positive polarity signal and a negative polarity signal of said input image signal corresponding to a signal that represents an amount of light that enters said liquid crystal panel.

### BRIEF DESCRIPTION OF DRAWINGS

FIG. 1 is a block diagram showing the structure of a liquid crystal display device according to a first exemplary embodiment of the present invention.

FIG. 2 is a schematic diagram exemplifying a lookup table (LUT) that represents the relationship between the amounts of light and common voltage values.

FIG. 3 is a flow chart showing a procedure of a common voltage controlling process performed in the liquid crystal display device shown in FIG. 1.

FIG. 4 is a schematic diagram exemplifying a lookup table (LUT) that represents the relationship between the amounts of light and center voltage values.

FIG. 5 is a flow chart showing a procedure of a center voltage controlling process performed in a liquid crystal display device according to a second exemplary embodiment of the present invention.

FIG. 6 is a block diagram showing the structure of a liquid crystal display device according to a third exemplary embodiment of the present invention.

FIG. 7 is a block diagram showing the structure of a liquid crystal display device according to a fourth exemplary embodiment of the present invention.

FIG. 8 is a waveform chart exemplifying the waveform of an image signal according to the line reverse driving scheme that reverses the polarity of the image signal every horizontal scanning interval.

### DESCRIPTION OF REFERENCE NUMERALS

10 Controlling section

11 Image signal processing circuit

12 Liquid crystal driving section

13 Liquid crystal panel

14 Storing section

15 Common voltage generating section

16 Buffer

17 Timer

18 Light detecting section

### BEST MODES THAT CARRY OUT THE INVENTION

Next, with reference to drawings, embodiments of the present invention will be described.

### First Exemplary Embodiment

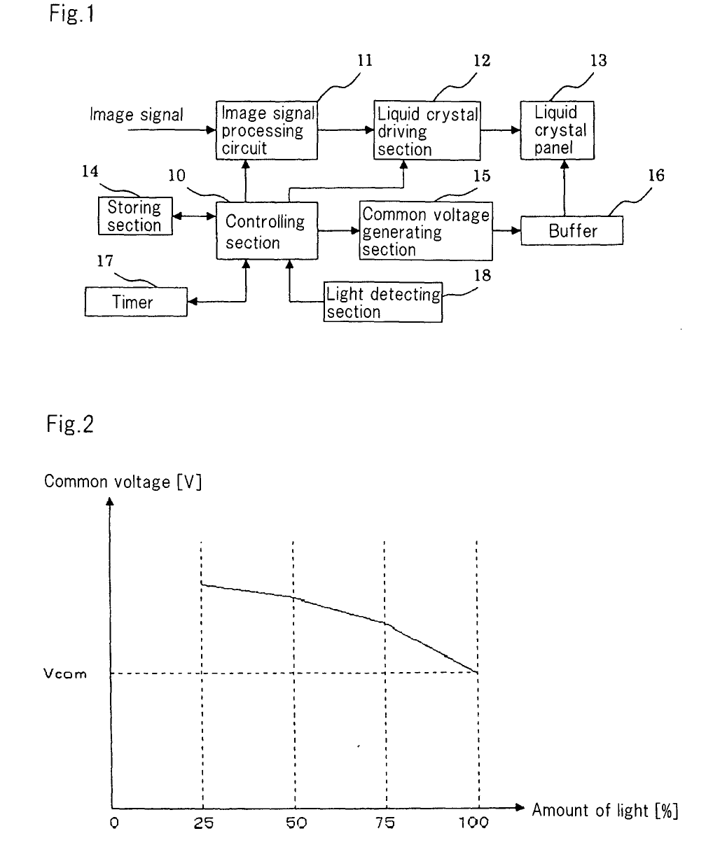

FIG. 1 is a block diagram showing the structure of a liquid crystal display device according to a first exemplary embodiment of the present invention.

Referring to FIG. 1, the liquid crystal display device include controlling section 10, image signal processing circuit 11, liquid crystal driving section 12, liquid crystal panel 13, storing section 14, common voltage generating section 15, buffer 16, timer 17, and light detecting section 18.

Liquid crystal panel 13 is a liquid crystal panel that performs the AC driving scheme that reverses the polarity of a voltage applied to pixel electrodes of a liquid crystal every predetermined period and includes a plurality of liquid crystal cells. Each liquid crystal cell is structured to sandwich a liquid crystal with two electrodes. One electrode is a pixel electrode corresponding to an image display pixel and an image signal voltage is supplied thereto through a thin film transistor (TFT). The electrode is charged and discharged by turning on and off the thin film transistor and a voltage corresponding to the image signal is set for the electrode. The other electrode is a common electrode connected to the plurality of liquid crystal cells and a DC voltage is applied to the electrode.

The AC driving scheme can be one scheme from among a dot reverse driving scheme, a line reverse driving scheme, a frame reverse driving scheme or a combination thereof. In this example, it is assumed that the line reverse driving scheme is applied. In the line reverse driving scheme, the polarity of a voltage supplied to the odd-numbered lines of rows (horizontal lines) of liquid crystal cells arranged in the horizontal direction of liquid crystal panel 13 and the polarity of the voltage supplied to the even-numbered lines thereof are reverse. Although the line reverse driving scheme includes the fixed line reverse driving scheme in which the polarity of the odd-numbered lines is positive and in which the polarity of the even-numbered lines is negative, and includes the frame and line reverse driving scheme that is a combination of the fixed line reverse driving scheme and the frame reverse driving scheme in which the polarity of the odd -numbered lines and the polarity of the even-numbered lines are reversed every frame (field), any one of those schemes can be applied.

Image signal processing circuit 11 performs a process required to display an image based on an image signal supplied from an external image signal source such as a personal computer on liquid crystal panel 13. An image signal supplied from image processing circuit 11 is converted into pixels of a proper size and supplied to liquid crystal driving section 12.

Liquid crystal driving section 12 drives liquid crystal panel 13 with AC power based on the image signal supplied from image signal processing circuit 11. When liquid crystal panel 13 is driven with AC power, liquid crystal driving section 12 reverses the polarity of the image signal based on the center voltage supplied from controlling section 10 every horizontal scanning interval.

Common voltage generating section 15 generates a common voltage corresponding to a common voltage value that has been set by controlling section 10. The common voltage generated by common voltage generating section 15 is supplied to the common electrode connected in common to each liquid crystal cell that composes liquid crystal panel 13 through buffer 16.

Light detecting section 18 detects the amount of light that enters liquid crystal panel 13. The amount of light that enters liquid crystal panel 13 can be relatively detected. Light detecting section 18 may be disposed in the vicinity of a light source that irradiates liquid crystal panel 13. In this case, light detecting section 18 detects the amount of white light irradiated by the light source. In addition, light detecting section 18 may be disposed in the vicinity of liquid crystal panel 13.

In the case of a three-panel type liquid crystal display device, light detecting section 18 is disposed in the vicinity of any one of liquid crystal panels. In this case, light detecting section 18 detects the amount of light of a single color that enters the liquid crystal panel. Alternatively, light detecting section 18 may detect part of light of white color irradiated by the light source or part of light of a single color that enters the liquid crystal panel through a reflection plate. If the distribution of wavelengths of light irradiated by the light source is nearly constant and if light detecting section 18 is disposed in the vicinity of the liquid crystal panel, the common voltages of other liquid crystal panels can be controlled based on the detected result of light of the single color (for example, green).

Storing section 14 has stored a table that represents the relationship between the amount of light and the common voltage. Specifically, a lookup table (LUT) that represents the relationship between the amounts of light and the common voltage values has been stored in storing section 14. Although the number of data entries of the LUT is decided based on the relationship between the amounts of light and the common voltages, if the data entries are linearly interpolated, the liquid crystal display device can be more accurately controlled. For example, in the case of the LUT shown in FIG. 2, although common voltage values corresponding to the amount of light 25%, 50%, 75%, and 100% are set, these values are linearly interpolated. On the LUT shown in FIG. 2, as the amount light increases, the common voltage lowers.

Controlling section 10 is composed of a CPU (Central Processor Unit) and controls the operations of image signal processing circuit 11, liquid crystal driving section 12, and common voltage generating section 15. With reference to the LUT stored in storing section 14, controlling section 10 decides a common voltage value corresponding to the amount of light detected by light detecting section 18 and sets the decided common voltage value for common voltage generating section 15.

Although the intervals at which light detecting section 18 detects the amount of light depend on how the common voltage deviates, if the intervals are several seconds, the characteristics of the liquid crystal panel do not occur. Therefore, the intervals may be several seconds. The intervals at which the amount of light is detected are measured by timer 17. Controlling section 10 decides the intervals at which light detecting section 18 detects the amount of light based on the measurement time of timer 17.

Next, a common voltage controlling process performed in the liquid crystal display device according to this embodiment will be described.

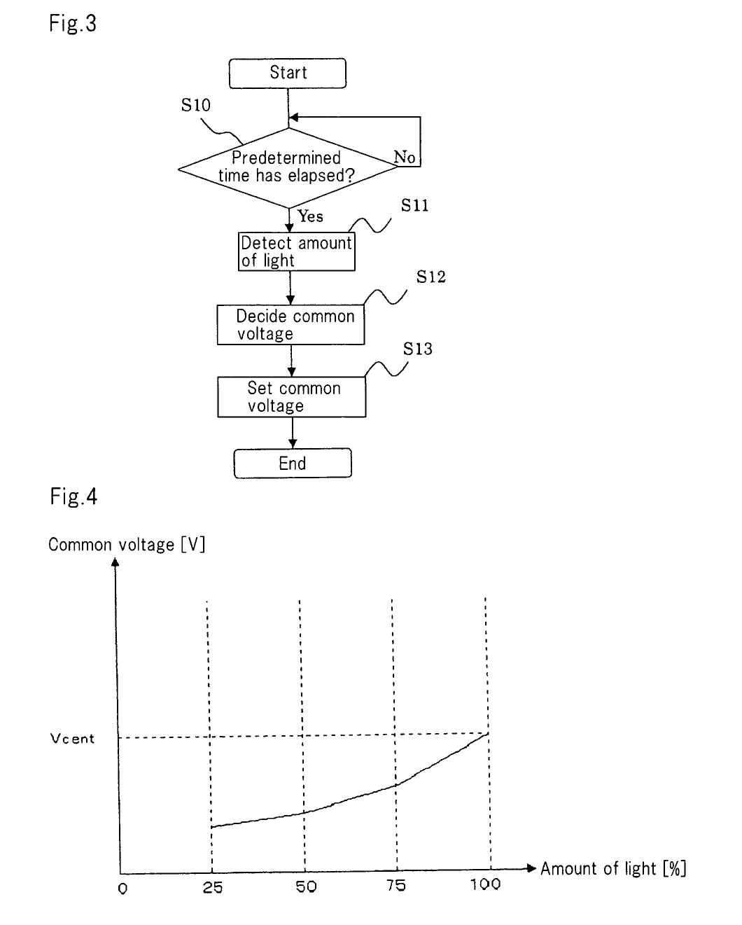

FIG. 3 is a flow chart showing a procedure of the common voltage controlling process.

Referring to FIG. 3, controlling section 10 determines whether or not the count value of timer 17 has reached a predetermined count value (at step S10).

If the count value has reached the predetermined count value, controlling section 10 causes light detecting section 18 to detect the amount of light (at step S11). Thereafter, with reference to the LUT stored in storing section 14, controlling section 10 decides a common voltage value corresponding to the amount of light detected by light detecting section 18 (at step S12). Thereafter, controlling section 10 sets the decided common voltage value for common voltage generating section 15 and then common voltage generating section 15 supplies a common voltage corresponding to the common voltage value, which has been set, to the common electrode connected in common to each liquid crystal cell that composes liquid crystal panel 13.

The liquid crystal display device according to this embodiment changes the common voltage supplied to the common electrode of liquid crystal panel 13 to an optimum value corresponding to the amount of light that enters liquid crystal panel 13 at predetermined time intervals. Thus, the characteristics of liquid crystal panel 13 can be prevented from deteriorating when the amount of light that enters liquid crystal panel 13 varies and thereby the optimum common voltage deviates. In addition, the worsening of flicker, the worsening of contrast, color shear, and so forth that occur due to deviation of the optimum common voltage can be prevented.

In the structure shown in FIG. 1, a means that changes the amount of light that enters the liquid crystal panel can be provided. This means can be a power controlling means or a light shading means according to a third exemplary embodiment and a fourth exemplary embodiment that will be described later. If the amount of light is detected when it is controlled, the load imposed on controlling section 10 can be reduced. At this point, since due to deterioration of the light source over time the amount of light varies generally in the order of several hours, the amount of light can be detected in intervals of several hours.

### Second Exemplary Embodiment

Although the structure of a liquid crystal display device according to this embodiment is the same as the structure shown in FIG. 1, they differ in that the former controls a center voltage corresponding to the amount of light that enters the liquid crystal panel instead of controlling the common voltage.

Storing section 14 has stored a table that represents the relationship between the amounts of light and the center voltages of the image signal. Specifically, a lookup table (LUT) that represents the relationship between the amounts of light and the center voltage values shown in FIG. 4 has been stored in storing section 14. Although the number of data entries of the LUT is decided based on the relationship between the amounts of light and the center voltages, if the data entries are linearly interpolated, the liquid crystal display device can be more accurately controlled.

For example, in the case of the LUT shown in FIG. 4, although center voltage values corresponding to the amount of light 25%, 50%, 75%, and 100% are set, these values are linearly interpolated. On the LUT shown in FIG. 4, as the amount of light increases, the center voltage rises. The variation of the center voltage on the LUT is just reverse of the variation of the common voltage on the LUT shown in FIG. 2.

Common voltage generating section 15 generates a common voltage corresponding to a common voltage value that has been set by controlling section 10. The common voltage value is a fixed value (an optimum value that has been set). The common voltage generated by common voltage generating section 15 is supplied to the common electrode connected in common to each liquid crystal cell that composes liquid crystal panel 13 through buffer 16.

With reference to the LUT stored in storing section 14, controlling section 10 decides a center voltage value corresponding to the amount of light detected by light detecting section 18 and supplies the decided center voltage value to liquid crystal driving section 12. Liquid crystal driving section 12 reverses the polarity of the image signal based on the center voltage value supplied from controlling section 10 every horizontal scanning interval.

Next, a center voltage controlling process performed in the liquid crystal display device according to this embodiment will be described.

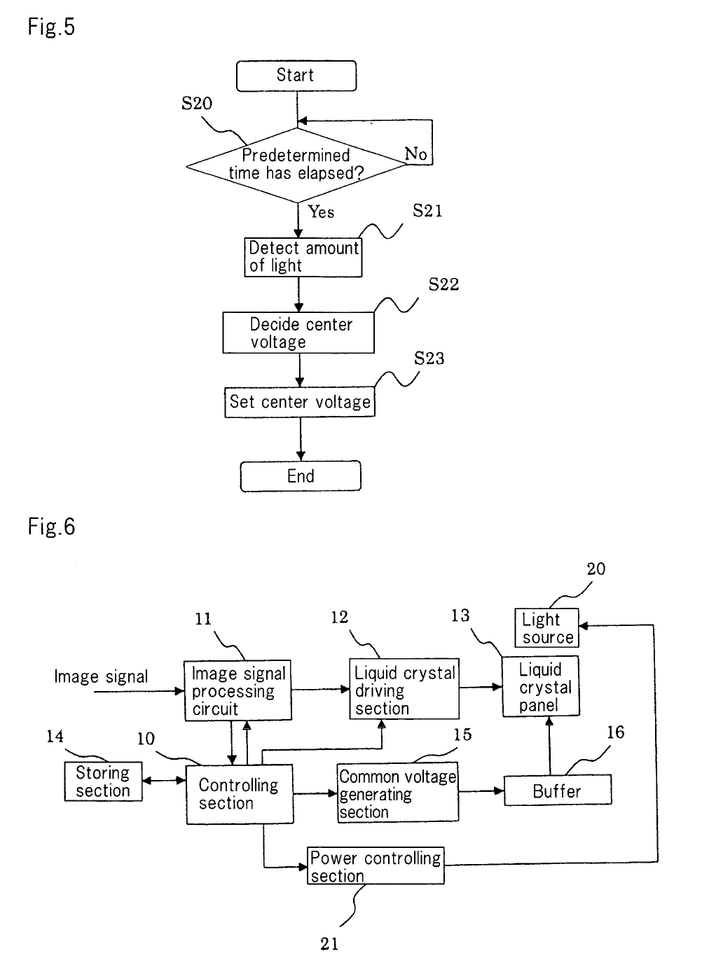

FIG. 5 is a flow chart showing a procedure of the center voltage controlling process. Referring to FIG. 5, controlling section 10 determines whether or not the count value of timer 17 has reached a predetermined count value (at step S20).

If the count value has reached the predetermined count value, controlling section 10 causes light detecting section 18 to detect the amount of light (at step S21). Thereafter, with reference to the LUT stored in storing section 14, controlling section 10 decides a center voltage value corresponding to the amount of light detected by light detecting section 18 (at step S22). Thereafter, controlling section 10 sets the decided center voltage value for liquid crystal driving section 12 and then liquid crystal driving section 12 reverses the polarity of the image signal based on the center voltage value that has been set every horizontal scanning interval. At this point, controlling section 10 controls liquid crystal driving section 12 such that the amplitude of the image signal does not vary.

The liquid crystal display device according to this embodiment changes the center voltage of liquid crystal panel 13 to an optimum value corresponding to the amount of light that enters liquid crystal panel 13 at predetermined intervals. Thus, the characteristics of liquid crystal panel 13 can be prevented from deteriorating when the amount of light that enters liquid crystal panel 13 varies and thereby the optimum common voltage deviates. In addition, worsening of flicker, worsening of contrast, color shear, and so forth that occur due to deviation of the optimum common voltage can be prevented.

### Third Exemplary Embodiment

FIG. 6 is a block diagram showing the structure of a liquid crystal display device according to a third exemplary embodiment of the present invention.

The liquid crystal display device according to this embodiment has the same structure as that shown in FIG. 1 except that timer 17 and light detecting section 18 are deleted and that light source 20 and power controlling section 21 are added.

The liquid crystal display device according to this embodiment uses the fact that there is a correlation between the power consumption of light source 20 and the amount of light that enters liquid crystal panel 13 and thereby controls the power consumption of light source 20 so as to control the amount of light and the common voltage value corresponding to a power consumption value. The other structure of this embodiment is the same as that of the first embodiment.

In the following, the characteristics of the liquid crystal display device according to this embodiment will be described in detail.

Image signal processing circuit 11 detects an APL (Average Picture Level) and a histogram of an input image signal and supplies the detected results to controlling section 10. Storing section 14 has stored characteristic data that represent the relationship between the power consumption values of light source 20 and the common voltage values as an LUT. If the LUT data entries are linearly interpolated, the liquid crystal display device can be more accurately controlled.

Controlling section 10 decides the ratio of a white area and a black area displayed on liquid crystal panel 13 based on the results detected by image signal processing circuit 11 and then decides a power consumption value of light source 20 based on the decided ratio. Specifically, when the image is bright, controlling section 10 increases the amount of power consumption for high brightness; when the image is dirk, controlling section 10 decreases the amount of power consumption of light source 20 for high contrast.

In addition, controlling section 10 supplies a command signal that contains the power consumption value decided based on the ratio of white and black areas to power controlling section 21. At the same time, with reference to the characteristic data stored in storing section 14, controlling section 10 decides a common voltage value corresponding to the decided power consumption value and causes common voltage generating section 15 to generate a common voltage corresponding to the common voltage value. Power controlling section 21 controls the power of light source 30 based on the power consumption value decided by controlling section 10.

Like the first embodiment, the liquid crystal display device according to this embodiment changes the common voltage supplied to the common electrode of liquid crystal panel 13 to an optimum value corresponding to the amount of light that enters liquid crystal panel 13. Thus, when power controlling section 21 controls power, even if the amount of light that enters liquid crystal panel 13 varies, since the common voltage is an optimum value, deterioration of characteristics of liquid crystal panel 13, worsening of flicker, worsening of contrast, color shear, and so forth can be prevented.

In the liquid crystal display device according to this embodiment, controlling section 10 sets the power consumption value for power controlling section 21 corresponding to the level of the input image signal and decides the common voltage value corresponding to the power consumption value with reference to the characteristic data stored in storing section 14. In this operation, controlling section 10 can decide a center voltage value instead of the common voltage value. In the following, this operation will be specifically described.

Storing section 14 has stored characteristic data that represent the relationship between the power consumption values of light source 20 and the center voltage values. Liquid crystal driving section 12 supplies a voltage corresponding to an input image signal whose polarity reverses every predetermined interval to a plurality of liquid crystal cells so as to display an image based on the input image signal on liquid crystal panel 13.

Controlling section 10 sets the power consumption value for power controlling section 21 corresponding to the level of the input image signal and decides a center voltage value corresponding to the power consumption value with reference to the characteristic data stored in storing section 14. Controlling section 10 changes the value of the center voltage supplied to liquid crystal panel 13 as an intermediate potential between the positive polarity signal and the negative polarity signal of the input image signal based on the decided center voltage value.

Since the common voltage can be an optimum value by controlling the center voltage corresponding to the amount of light that enters liquid crystal panel 13, characteristic deterioration of liquid crystal panel 13, worsening of flicker, worsening of contrast, color shear, and so forth can be prevented.

According to this embodiment, the amount of light of light source 20 deteriorates (darkens) due to the characteristics of light source 20 that varies with time. A process that pre-obtains characteristic data that represent the degree of aged tolerance (characteristic data of average value of deterioration) and controls the power consumption based on the characteristic data such that the amount of light that enters liquid crystal panel 13 becomes constant can be added.

### Fourth Exemplary Embodiment

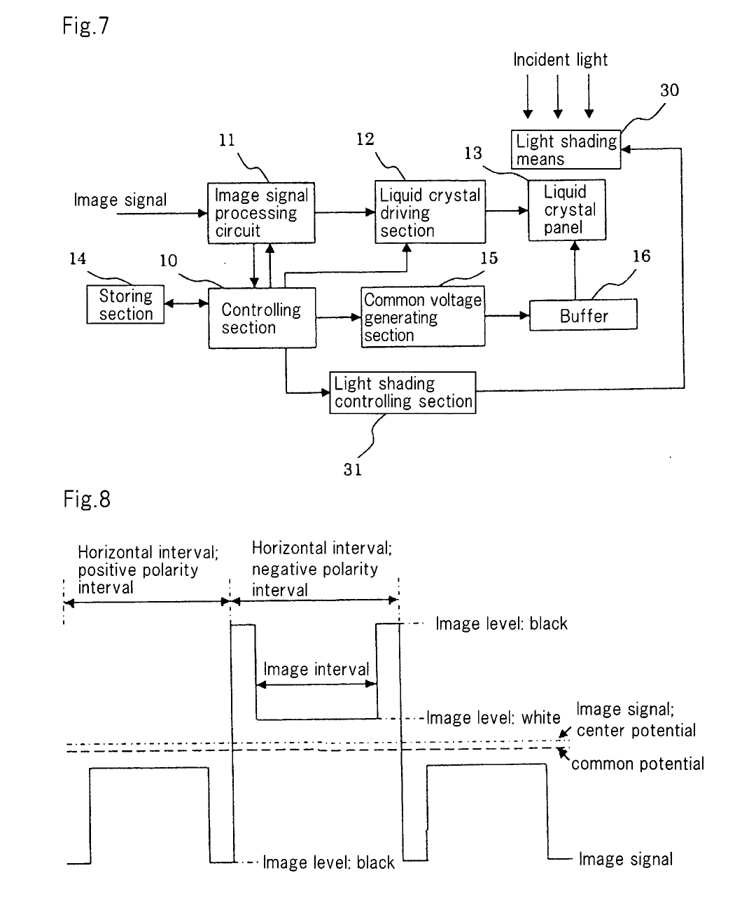

FIG. 7 is a block diagram showing the structure of a liquid crystal display device according to a fourth exemplary embodiment of the present invention.

The liquid crystal display device according to this embodiment has the same structure as that shown in FIG. 1 except that timer 17 and light detecting section 18 are deleted and that light shading means 30 and light shading controlling section 31 are added.

The liquid crystal display device according to this embodiment uses the fact that there is a correlation between a transmissivity (light shading ratio) represented by the ratio of the intensity of light that has passed through light shading means 30 and the intensity of incident light and the amount of light that enters liquid crystal panel 13 and controls the transmissivity of light shading means 30 so as to control the amount of light and a common voltage value corresponding to the transmissivity. The other structure of this embodiment is the same as that of the first embodiment.

In the following, the characteristics of the liquid crystal display device according to this embodiment will be described in detail.

Image signal processing circuit 11 detects an APL and a histogram of an input image signal and supplies the detected results to controlling section 10. Storing section 14 has stored characteristic data that represent the relationship between the transmissivities of light shading means 30 and the common voltage values as an LUT. If the LUT data entries are linearly interpolated, the liquid crystal display device can be more accurately controlled.

Controlling section 10 decides the ratio of a white area and a black area displayed on liquid crystal panel 13 based on the results detected by image signal processing circuit 11 and then decides the transmissivity of light shading means 30 based on the decided ratio. Specifically, when the image is bright, controlling section 10 increases the transmissivity of light shading means 30 for high brightness; when the image is dark, controlling section 10 decreases the transmissivity of light shading means 30 for high contrast.

In addition, controlling section 10 supplies a command signal that contains the transmissivity decided based on the ratio of white and black areas to light shading controlling section 31. At the same time, controlling section 10 decides a common voltage value corresponding to the decided transmissivity with reference to the characteristic data stored in storing section 14 and causes common voltage generating section 15 to generate the common voltage corresponding to the common voltage value.

Light shading controlling section 31 controls the amount of light that shading means 30 uses to shade the incident light based on the transmissivity decided by controlling section 10. Light shading means 30 is for example a diaphragm and a shutter used for a camera or the like. Light shading controlling section 31 controls the size of the aperture of the diaphragm so as to control the amount of light that shading means 30 uses to shade the incident light.

Like the first embodiment, the liquid crystal display device according to this embodiment changes the common voltage supplied to the common electrode liquid crystal panel 13 to an optimum value corresponding to the amount of light that enters liquid crystal panel 13. Thus, when light shading controlling section 31 controls light shading, even if the amount of light that enters liquid crystal panel 13 varies, since the common voltage is an optimum value, deterioration of characteristics of liquid crystal panel 13, worsening of flicker, worsening contrast, color shear, and so forth can be prevented.

In the liquid crystal display device according to this embodiment, controlling section 10 sets the transmissivity for light shading controlling section 31 to correspond to the level of the input image signal and decides a common voltage value corresponding to the transmissivity with reference to the characteristic data stored in storing section 14. In this operation, controlling section 10 can decide a center voltage value instead of the common voltage value. In the following, this operation will be specifically described.

Storing section 14 has stored characteristic data that represent the relationship between the light shading ratios of light shading means 30 and the center voltage values. Liquid crystal driving section 12 supplies a voltage corresponding to an input image signal whose polarity reverses every predetermined interval to a plurality of liquid crystal cells so as to display an image based on the input image signal on liquid crystal panel 13.

Controlling section 10 sets the transmissivity for light shading controlling section 31 to correspond to the level of the input image signal and decides a center voltage value corresponding to the transmissivity with reference to the characteristic data stored in storing section 14. Controlling section 10 changes the value of the center voltage supplied to liquid crystal panel 13 as an intermediate potential between the positive polarity signal and the negative polarity signal of the input image signal based on the decided center voltage value.

Since the common voltage can be an optimum value by controlling the center voltage corresponding to the amount of light that enters liquid crystal panel 13, deterioration of characteristics of liquid crystal panel 13, worsening of flicker, worsening of contrast, color shear, and so forth can be prevented.

According to this embodiment, the amount of light of light source 20 deteriorates (darkens) due to variation in the characteristics of light source 20 over time. A process in which characteristic data, which represent the degree of deterioration of light of light source 20 which is arisen due to variation in the characteristics of light source 20 over time (average value of the deterioration characteristic of characteristics data), is pre-obtained and in which the light shading ratio is controlled based on the characteristic data, such that the amount of light that enters liquid crystal panel 13 becomes constant, can be added.

The above-described embodiments are examples of the present invention and thereby the structure and operation of the present invention may be changed in various manners without departing from the spirit of the present invention.

The present invention can be applied to various types of liquid crystal display devices that use a liquid crystal panel, these devices including a projector and so forth.

1. A liquid crystal display device including a liquid crystal panel, comprising:
a common voltage generating section that supplies a common voltage to a common electrode connected in common to a plurality of liquid crystal cells that compose said liquid crystal panel;
a liquid crystal driving section that supplies a voltage corresponding to an input image signal to said plurality of liquid crystal cells so as to display an image based on said input image signal on said liquid crystal panel; and
a controlling section that causes said common voltage generating section to change a value of the common voltage generated thereby to correspond to a signal that represents an amount of light that enters said liquid crystal panel.

2. The liquid crystal display device as set forth in claim 1, further comprising:
a light detecting section that detects the amount of light that enters said liquid crystal panel; and
a storing section that has stored characteristic data that represent a relationship between the amounts of light that enters said liquid crystal panel and common voltage values,
wherein said controlling section decides a common voltage value corresponding to the amount of light detected by said light detecting section with reference to the characteristic data stored in said storing section and causes said common voltage generating section to generate a common voltage corresponding to the common voltage value.

3. The liquid crystal display device as set forth in claim 1, further comprising:
a light source that irradiates said liquid crystal panel;
a power controlling section that controls power of said light source based on a power consumption value that has been set; and
a storing section that has stored characteristic data that represent a relationship between the power consumption values of said light source and common voltage values,
wherein said controlling section sets a power consumption value for said power controlling section to correspond to a level of said input image signal, decides a common voltage value corresponding to the power consumption value with reference to the characteristic data stored in said storing section, and causes said common voltage generating section to generate a common voltage corresponding to the common voltage value.

4. The liquid crystal display device as set forth in claim 1, further comprising:
light shading means that is disposed on a light incident side of said liquid crystal panel and that shades part of incident light so as to adjust the amount of light that enters said liquid crystal panel;
a storing section that has stored characteristic data that represent a relationship between transmissivities, that are ratios of an intensity of light that has passed through said light shading means and an intensity of light that has entered said light shading means, and common voltage values; and
a light shading controlling section that controls an amount of light that said light shading means uses to shade incident light based on a transmissivity that has been set,
wherein said controlling means sets a transmissivity for said light shading controlling section to correspond to a level of said input image signal, decides a common voltage value corresponding to the transmissivity with reference to the characteristic data stored in said storing section, and causes said common voltage generating section to generate a common voltage corresponding to the common voltage value.

5. A liquid crystal display device that has a liquid crystal panel, comprising:
a common voltage generating section that supplies a common voltage to a common electrode connected in common to a plurality of liquid crystal cells that comprise said liquid crystal panel;
a liquid crystal driving section that supplies a voltage corresponding to an input image signal whose polarity reverses every predetermined interval to said plurality of liquid crystal cells so as to display an image based on said input image signal on said liquid crystal panel; and
a controlling section that changes a value of a center voltage supplied to said liquid crystal panel as an intermediate potential between a positive polarity signal and a negative polarity signal of said input image signal corresponding to a signal that represents an amount of light that enters said liquid crystal panel.

6. The liquid crystal display device as set forth in claim 5, further comprising:
a light detecting section that detects the amount of light that enters said liquid crystal panel; and
a storing section that has stored characteristic data that represent a relationship between said amounts of light that enter said liquid crystal panel and the center voltage values,
wherein said controlling section decides a center voltage value corresponding to the amount of light detected by said light detecting section with reference to the characteristic data stored in said storing section and changes a value of the center voltage supplied to said liquid crystal panel based on the decided center voltage value.

7. The liquid crystal display device as set forth in claim 5, further comprising:
a light source that irradiates said liquid crystal panel;
a power controlling section that controls power of said light source based on a power consumption value that has been set; and
a storing section that has stored characteristic data that represent a relationship between the power consumption values of said light source and the center voltage values,
wherein said controlling section sets a power consumption value for said power controlling section to correspond to a level of said input image signal, decides a center voltage value corresponding to the power consumption value with reference to the characteristic data stored in said storing section, and changes a value of the center voltage supplied to said liquid crystal panel based on the decided center voltage value.

8. The liquid crystal display device as set forth in claim 5, further comprising:
light shading means that is disposed on a light incident side of said liquid crystal panel and that shades part of incident light so as to adjust the amount of light that enters said liquid crystal panel;
a storing section that has stored characteristic data that represent a relationship between transmissivities, that are ratios of an intensity of light that has passed through said light shading means and an intensity of light that has entered said light shading means, and center voltage values; and
a light shading controlling section that controls an amount of light that said light shading means uses to shade incident light based on a transmissivity that has been set,
wherein said controlling means sets a transmissivity for said light shading controlling section to correspond to a level of said input image signal, decides a center voltage value corresponding to the transmissivity with reference to the characteristic data stored in said storing section, and changes a value of the center voltage supplied to said liquid crystal panel based on the decided center voltage value.

9. A driving method for a liquid crystal panel composed of a plurality of liquid crystal cells, comprising:
supplying a voltage corresponding to an input image signal to said plurality of liquid crystal cells so as to display an image based on said input image signal on said liquid crystal panel and then supplying a common voltage to a common electrode connected in common to said plurality of liquid crystal cells; and
changing a value of the common voltage supplied to said common electrode to correspond to a signal that represents an amount of light that enters said liquid crystal panel.

10. A driving method for a liquid crystal panel composed of a plurality of liquid crystal cells, comprising:
supplying a voltage corresponding to an input image signal whose polarity reverses every predetermined interval to said plurality of liquid crystal cells so as to display an image based on said input image signal on said liquid crystal panel and then supplying a common voltage to a common electrode connected in common to said plurality of liquid crystal cells; and
changing a value of a center voltage supplied to said liquid crystal panel as an intermediate potential between a positive polarity signal and a negative polarity signal of said input image signal corresponding to a signal that represents an amount of light that enters said liquid crystal panel.
